(19) United States
(12) Patent Application Publication
(10) Pub. No.: US 2009/0028141 A1
(43) Pub. Date: Jan. 29, 2009

(54) Method and device for controlling admission to a guaranteed quality of service in a mpls network

(76) Inventors: Thang Vu Duong, Ploulec'h (FR); Gael Fromentoux, Pleumeur-Bodou (FR); Jean-Louis Le Roux, Lannion (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/664,910

(22) PCT Filed: Sep. 28, 2005
(86) PCT No.: PCT/FR05/02406

§ 371 Date: Apr. 10, 2008

(30) Foreign Application Priority Data
Oct. 8, 2004 (FR) 04/10,675

(51) Int. Cl. H04L 12/56; H04L 29/06

(52) U.S. Cl. 370/389

(57) ABSTRACT

The invention concerns a method and a device for controlling admission to a guaranteed quality of service in a MPLS network (150), the MPLS network consisting of at least one input peripheral router (100) and one output peripheral router (120), the data flows being transported in the MPLS network through tunnels. The invention is characterized in that the input peripheral router receives request from a client (180a) for setting up a guaranteed quality of service in the MPLS network, obtains traffic engineering parameters corresponding to the service requested by the client, determines whether the creation of a tunnel for transporting the data flow(s) related to the guaranteed quality of service between the input peripheral router and the output peripheral router is possible in the MPLS network and transfers to the client a message of denial of the request of the client for setting up a guaranteed quality of service in the MPLS network if it is not possible to create a tunnel for carrying the data flow(s) related to the guaranteed quality of service between the input peripheral router and the output peripheral router in the network.

### BACKGROUND OF THE INVENTION

The present invention relates to a method and a device for controlling admission to a service with guaranteed quality of service in a telecommunication network.

More specifically, the present invention relates to a distributed method of controlling admission to a service with guaranteed quality of service in an MPLS (Multi-Protocol Label Switching) label-switched telecommunication network.

### DESCRIPTION OF THE PRIOR ART

The MPLS standard, published under the auspices of the IETF (Internet Engineering Task Force) is a technique based on label switching that makes it possible to create a connection-oriented network from a datagram-type network such as the IP network. Detailed documentation on the MPLS protocol can be found on the Internet at www.ietf.org.

FIG. 1 diagrammatically shows an MPLS network 150, comprising a plurality of routers called LSR (Label Switching Routers) such as 100a, 100b, 110a, 110b, 110c and 120 interlinked by IP links. When an IP packet arrives at an ingress edge router 100a or 100b, called ingress LSR, the latter assigns it a label according to its IP header and concatenates it with said packet. The router that receives the labeled packet replaces the label (incoming) with an outgoing label according to its routing table and the process is repeated from router to router to the egress edge router 120 (also called egress LSR) which deletes the label before transmitting the packet. Alternatively, the deletion of the label may already have been done by the penultimate router since the egress router 120 does not use the incoming label. An LSR router uses the label of the incoming packet (incoming label) to determine the output port and the label of the outgoing packet (outgoing label). The path taken by a packet through the network from the ingress router 100a to the egress router 120 is called Label-Switched Path or LSP. According to the example of FIG. 1, in which a path is represented by the arrows 105a, 105b and 105c, the LSR routers 110a, 110c crossed by the path and distinct from the ingress edge routers 100a and egress edge routers 120 are called transit routers. Also, the term Forward Equivalence Class (FEC) is used to denote the set of IP packets that are transmitted along one and the same path.

The MPLS protocol makes it possible to force the IP packets to follow a preestablished LSP path which is not normally the optimal IP path in terms of number of hops or path metric. The technique for determining the path or paths to be taken is called traffic engineering or MPLS-TE (for MPLS Traffic Engineering). The determination of the path takes into account constraints on the available resources (constraint based routing), particularly in terms of bandwidth on the various links of the network. Unlike the conventional IGP routing that works according to a hop-by-hop routing mode, the determination of an LSP path is performed according to a so-called explicit mode (explicitly-routed LSP or ER-LSP), wherein some or all of the nodes of the path from the ingress router to the egress router are determined. When all the nodes of the path are fixed, the term “explicit routing” applies in the strict sense. A path determined according to an explicit mode is also called MPLS tunnel.

The choice of one or more MPLS tunnels can be made centrally or in a distributed way. According to the distributed method based on the constraint-based routing technique, each router is informed as to the topology of the network and the constraints affecting the various links of the network. For this, each router determines and transmits to its neighbors a message indicating its immediate links and the constraints (or attributes) that are associated with it. These messages are then propagated from node to node by extended IGP messages, according to a flooding mechanism, until all the routers are informed. Thus, each router has its own database (called TED, standing for Traffic Engineering Database) giving it the topology of the network and its constraints.

The determination of the label-switched path is then made by the ingress edge router by also taking into account other constraints fixed by the network operator (for example, avoid such and such a node or avoid the links of such and such a type). The ingress edge router then determines, for example by means of the Dijkstra algorithm, the shortest path satisfying all the constraints (Constraint Shortest Path First, CSPF), those affecting the links like those fixed by the operator. This shortest path is then signaled to the routers of the LSP path by means of the signaling protocols known by the abbreviations RSVP-TE (Resource reSerVation Protocol for Traffic Engineering), or even CR-LDP (Constrained Route Label Distribution Protocol). A description of the RSVP-TE protocol can be found in the document by D. Adwuche et al. entitled: “RSVP-TE: extensions to RSVP for LSP tunnels”, available from the abovementioned IETF site.

These MPLS signaling protocols make it possible to distribute labels along the path and reserve resources.

For example, if the RSVP signaling protocol is used, the ingress router 100a transmits a Path message in an IP packet to the egress router 120. This message specifies the list of nodes 110a, 110c through which the LSP path must pass. At each node, the Path message establishes the path and makes a status reservation. When the Path message reaches the egress router 120, an acknowledgement message Resv is returned by the same path to the ingress router 100a.

At each node, the MPLS routing table is updated and resources are reserved. For example, if the resource is a bandwidth and there is a desire to reserve 10 Mbits for the path, the bandwidths respectively assigned to each link are decremented by the reserved value of 10 Mbits on the back-propagation of the acknowledgement/reservation message. It should be noted that the resource concerned (for example the bandwidth) is a logical resource on the IP link and not a physical resource. When the acknowledgement message is received by the ingress router, the tunnel is set up.

As has been stated above, the determination of the LSP paths can be performed centrally. In this case, a server knows the topology of the network and takes into account the constraints of the links and the constraints fixed by the network operator to determine the tunnels between the ingress routers and the egress routers. The ingress edge routers are then notified by the server of the tunnel or tunnels for which they are the input node. The tunnels are then set up as indicated previously.

IETF recommendation RFC 2475 entitled “An architecture for Differentiated Services” proposes a method wherein priorities are allocated according to classes to the IP data flows in the MPLS network 150. These classes are defined based on the DSCP fields of the IP packets transferred in the MPLS network. DSCP is an acronym standing for “DiffServ Code Point”. This method guarantees that the priority data flows will be processed in preference to the lower priority data flows, but it does not guarantee any quality of service, for example in terms of bandwidth reservation, for the data flows that are crossing the MPLS telecommunication network.

IETF recommendation RFC 3270 entitled “MPLS support for differenciated services” proposes a method wherein priorities are allocated to both the MPLS data frames and the IP packets without taking into account the constraints of each class for their routing. This method is thus based on an aggregated routing of the different classes of service in each LSP router of the MPLS network and does not make it possible to guarantee a quality of service for each service class and each information flow.

IETF recommendation RFC 3564 entitled “Requirements for support of Differentiated Services-aware MPLS Traffic Engineering” proposes a method wherein the routing of the information flows is performed by considering the constraints linked to each service class and thus makes it possible to guarantee a certain quality of service in the MPLS network.

These techniques do not offer a method of controlling admission to a service with guaranteed quality of service in a label-switched telecommunication network. When a large number of customers access services with guaranteed quality of service in a label-switched telecommunication network, the flows transferred when these services are set up are sometimes so great that it is no longer possible for the label-switched telecommunication network to provide transport for them while observing a quality of service, thus penalizing at least some of the customers using these services.

Some relatively small telecommunications networks use centralized systems for controlling admission to a service with guaranteed quality of service. Such systems are not suited to a large label-switched telecommunication network.

### SUMMARY OF THE INVENTION

The aim of the invention is to resolve the drawbacks of the prior art by proposing a distributed method and device for controlling admission to a service with guaranteed quality of service in a large size MPLS label-switched telecommunication network.

To this end, according to a first aspect, the invention proposes a method of controlling admission to a service with guaranteed quality of service in a label-switched telecommunication network, the label-switched telecommunication network comprising at least one ingress edge router and one egress edge router, the data flows being carried in the label-switched telecommunication network in tunnels.

According to the invention, this method comprises the following steps performed by the ingress edge router of:
receiving a request from a customer to set up a service with guaranteed quality of service in the telecommunication network,
obtaining traffic engineering parameters corresponding to the service requested by the customer,
determining whether a tunnel to carry the data flow or flows linked to the service with guaranteed quality of service can be created between the ingress edge router and the egress edge router in the label-switched telecommunication network,
transferring to the customer a message denying the request from the customer to set up a service with guaranteed quality of service in the telecommunication network if a tunnel to carry the data flow or flows linked to the service with guaranteed quality of service cannot be created between the ingress edge router and the egress edge router in the label-switched telecommunication network.

Correlatively, the invention relates to a device for controlling admission to a service with guaranteed quality of service in a label-switched telecommunication network, the label-switched telecommunication network comprising at least one ingress edge router and one egress edge router, the data flows being carried in the label-switched telecommunication network in tunnels.

According to the invention, this admission control device is included in the ingress edge router and comprises:
means of receiving a request from a customer to set up a service with guaranteed quality of service in the telecommunication network,
means of obtaining traffic engineering parameters corresponding to the service requested by the customer and rules applicable for making available resources of the label-switched telecommunication network,
means of determining whether a tunnel to carry the data flow or flows linked to the service with guaranteed quality of service can be created between the ingress edge router and the egress edge router in the label-switched telecommunication network,
means of denying the request from the customer to set up a service with guaranteed quality of service in the telecommunication network if a tunnel to carry the data flow or flows linked to the service with guaranteed quality of service cannot be created between the ingress edge router and the egress edge router in the label-switched telecommunication network.

Thus, by controlling admission to a service with guaranteed quality of service in a label-switched telecommunication network, it is possible to avoid having the label-switched telecommunication network congested. Furthermore, by delegating the admission control task to each ingress edge router of the label-switched telecommunication network, the problems linked to the centralized systems are resolved simply.

According to another aspect of the invention, if a tunnel to carry the data flow or flows linked to the service with guaranteed quality of service can be created between the ingress edge router and the egress edge router in the label-switched telecommunication network, a message is transferred to the customer accepting the request from the customer to set up a service with guaranteed quality of service in the telecommunication network.

Thus, it is possible to guarantee to each customer wanting access to a service with guaranteed quality of service in the telecommunication network that the quality of service will be maintained throughout the communication session. In practice, no congestion of the telecommunication network is likely to appear, the setup requests being denied when the resources of the telecommunication network become limited.

According to another aspect of the invention, prior to the step for determining whether a tunnel to carry the data flow or flows linked to the service with guaranteed quality of service can be created between the ingress edge router and the egress edge router in the label-switched telecommunication network, a determination is made as to whether a tunnel of the label-switched telecommunication network is able to carry the data flow or flows linked to the service with guaranteed quality of service between the ingress edge router and the egress edge router.

This makes it possible to avoid having too many tunnels created in the label-switched telecommunication network. The use of the existing tunnels in the telecommunication network is thus optimized, as are the resources of the telecommunication network.

According to another aspect of the invention, on obtaining traffic engineering parameters corresponding to the service requested by the customer, rules are also obtained that are applicable to the customer to make available resources of the label-switched telecommunication network.

Thus, it is possible to control the resources of the network made available to a customer.

According to another aspect of the invention, prior to obtaining traffic engineering parameters corresponding to the service requested by the customer and rules applicable to the customer for making available resources of the label-switched telecommunication network, a check is carried out, via a network controller, as to whether the customer having sent the request is authorized to access the service with guaranteed quality of service.

Thus, it is possible to restrict access to the services proposed by the telecommunication network.

According to another aspect of the invention, the engineering parameters corresponding to the service requested by the customer comprise at least one of the elements of the group containing the bit rate allocated for a service, the processing delay, the traffic engineering service class and the fact that the service is unidirectional or bidirectional.

According to another aspect of the invention, the rules applicable to the customer comprise at least one of the elements of the group containing the maximum bit rate authorized for all the services requested by the customer and the maximum number of sessions authorized for the customer.

According to another aspect of the invention, a database referencing all accesses by the customers linked to the ingress edge router to the services with guaranteed quality of service in the telecommunication network is updated.

The invention also relates to a computer program stored on an information medium, said program comprising instructions for implementing the method described previously, when it is loaded and run by a computer system.

### BRIEF DESCRIPTION OF THE DRAWINGS

The abovementioned characteristics of the invention, and others, will become more clearly apparent from reading the following description of an exemplary embodiment, said description being given in relation to the appended drawings, in which:

FIG. 1 represents a telecommunication network using the MPLS protocol in which the present invention is implemented;

FIG. 2 is a functional representation of the ingress edge router according to the present invention;

FIG. 3 represents the algorithm run by the ingress edge router according to the present invention.

### DESCRIPTION OF THE PREFERRED EMBODIMENTS

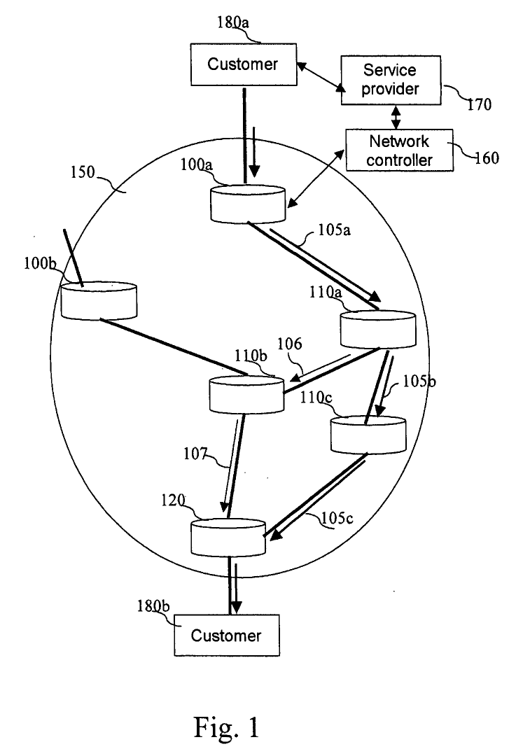

FIG. 1 represents a telecommunication network using the MPLS protocol in which the present invention is implemented.

The MPLS network 150 is accessible to customer devices 180, hereinafter called customers 180, to transmit and/or receive information. According to the example of FIG. 1, only two customers 180a and 180b are linked to the MPLS network 150. Naturally, more customers 180 access the MPLS network 150.

The customers 180a and 180b are linked to the MPLS network 150 via a conventional Internet-type network, not shown in FIG. 1, or by a direct link able to transport IP packets with the MPLS network 150.

To access the service providing service with guaranteed quality of service, a customer, for example the customer 180a, must subscribe to a service provider 170 for such a service. The service provider 170 is, for example, and in a non-limiting way, a service provider 170 offering the facility for the customer 180a to access the Internet network with a guaranteed bandwidth and/or to set up conference sessions between at least two customers in which a certain quality of service is guaranteed.

When the customer 180a subscribing to such services wants a communication session to be set up, the latter generates a session setup request to the ingress edge router 100a with which it is associated. The session setup request comprises, among other things, an identifier of the customer 180a and the identifier of the requested service, even a password or an identifier of the correspondent with which the customer 180a wants the service to be set up.

The ingress edge router 100a transfers, according to the invention, the request to access a network controller 160 included or not included in the MPLS network 150. The network controller 160 is able to process the various requests transferred by the ingress edge routers 100a and 100b of the MPLS network 150. The network controller 160 stores the various traffic engineering parameters corresponding to each of the services accessible to the customers 180 and the applicable rules for making available resources of the MPLS network 150. The engineering parameters are, for example and in a non-limiting way, the bit rate allocated for a service, the processing delay and the traffic engineering service class, and the fact that the service is unidirectional or bidirectional. The network controller 160 is able to interrogate the service provider 170 of the customer 180a so as to check whether the customer 180a is authorized to use such a service. The network controller 160 communicates to the service provider 170 whose identifier is included in the request from the customer 180a, the identifier of the customer 180a and the identifier of the requested service. The service provider 170, according to the subscription of the customer 180a, authorizes or denies access to such a service. The network controller 160 transfers to the ingress edge router 100a the various traffic engineering parameters corresponding to the service that can be accessed by the customer 180a and the rules applicable for making available resources of the MPLS network 150 when the customer 180a is authorized to access the service or to transfer to the ingress edge router 100a a message representative of the denial, by the access provider 170 of the service access request. The ingress edge router 100a is able to allocate a tunnel in the MPLS network 150 to set up the requested session. The allocated tunnel is an existing tunnel or a tunnel created for the requested session.

The ingress edge router 100a is able to authorize or deny access to the MPLS network 150 according to the available resources of the MPLS network 150 and the service engineering parameters provided by the network controller 160.

The ingress edge router 100a is able to authorize or deny access to the MPLS network 150 according to the MPLS network resources already allocated to the customer 180a.

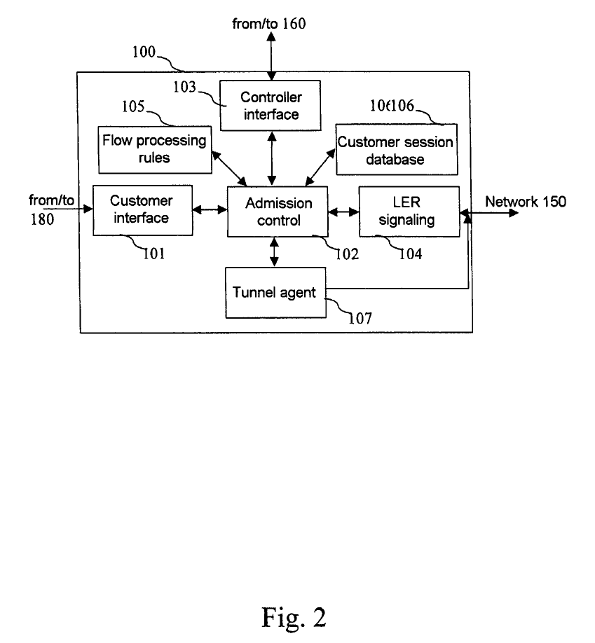

FIG. 2 is a functional representation of the ingress edge router according to the present invention.

An ingress edge router 100 according to the invention comprises a customer interface module 101. The customer interface module 101 handles the transmission of messages to the customer 180a and/or the reception of messages sent by the customer 180a when the latter wants to access a service with guaranteed quality of service. The customer interface module 101 receives from the customer 180a a request to access a service with guaranteed quality of service. This request comprises, among other things, an identifier of the requested service, an identifier of the customer 180a, the destination IP address with which the customer 180a wants the service with guaranteed quality of service to be set up, even a password for authenticating the customer 180a to the requested service. The customer interface module 101 is able to transfer the content of each request to the admission control module 102 of the ingress edge router 100. The customer interface module 101 is able to transfer to the customer 180a messages representative of the acceptance or denial of access to the service with guaranteed quality of service.

The admission control module 102 is able to process a request made by a customer 180a to access a service with guaranteed quality of service. For this, the admission control module 102 controls the generation of a request to the network controller 160 to access the requested service. This request is transmitted via the controller interface 103 and comprises the identifier of the requested service, the identifier of the customer 180, the destination IP address with which the customer 180 wants the service with guaranteed quality of service to be set up, the IP address of the ingress edge router 100a, even a password for authenticating the customer 180 to the requested service.

The admission control module 102 obtains the processing rules to be observed for the requested service. These processing rules are obtained from the flow processing base 105 of the ingress edge router 100 or of the network controller 160. Preferably, the admission control module 102 obtains the processing rules from the flow processing base 105. Subject to certain conditions, for example when the flow processing base 105 does not include the processing rules relating to a service requested by a customer or when the processing rules relating to a service requested by a customer are included from a predetermined time in the flow processing base 105, the admission control module 102 obtains the processing rules from the network controller 160. The admission control module 102 is able to update the flow processing base 105 with the data transmitted by the network controller 160.

The admission control module 102 is able to control the generation of a message denying access to the service requested by the customer 180 if the controller 160 of the MPLS network has responded negatively to the request.

When the processing rules to be observed for the requested service have been obtained, the admission control module 102 is able to order the tunnel agent 107 of the ingress edge router 100 to set up a connection that is able to support the service requested by the customer 180. The tunnel agent 107 selects an existing tunnel between the ingress and egress edge routers or creates, based on processing rules comprising the traffic engineering parameters linked to the requested service, a new connection between the ingress and egress edge routers.

The tunnel agent 107 dialogs with the egress edge router 120 to which the destination IP address with which the customer 180 wants the data flow transfer service according to a guaranteed quality of service to be set up is attached.

The egress edge router 120 is determined for example based on the destination IP address with which the customer 180 wants the service with guaranteed quality of service to be set up. The tunnel agent 107 transfers to the egress edge router 120 the identifier of the tunnel used for the service in the ingress edge router to egress edge router direction and having to be used by the egress edge router in the egress edge router to ingress edge router direction. This transfer is handled via the admission control module 102 and the signaling module 104.

The tunnel agent 107 determines the shortest path satisfying all the constraints. This shortest path is then signaled to the routers of the LSP path by means of the signaling protocols known by the abbreviations RSVP-TE or CR-LDP.

The ingress edge router also comprises a customer session database 106. The customer session database 106, accessible by the admission control module 102, stores the information linked to each of the service sessions that pass through the ingress edge router 100. For each of the current sessions, the traffic engineering parameters allocated to the session are stored in the customer session database 106. The customer session database 106 is updated by the admission control module 102 when sessions are set up or stopped.

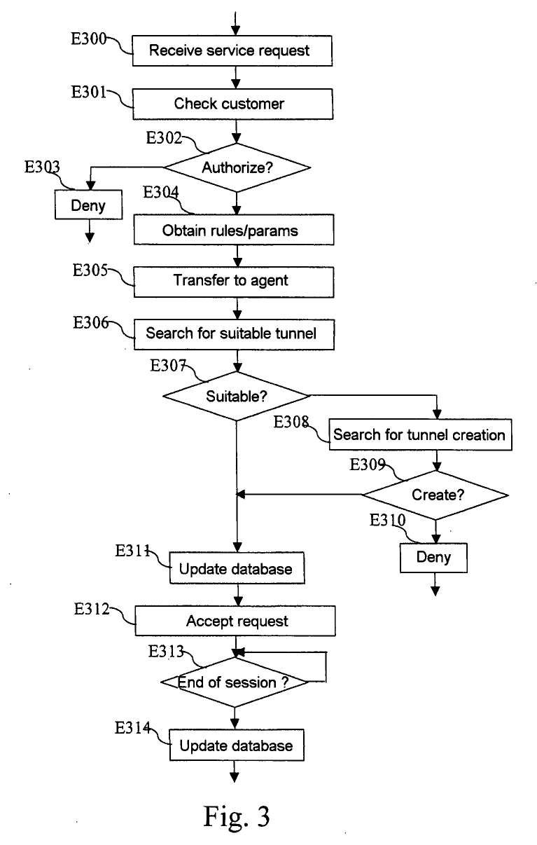

FIG. 3 represents the algorithm run by the ingress edge router according to the present invention.

The algorithm of FIG. 3 is run by each ingress edge router 100 of the MPLS network 150.

In the step E300, a request to access a service with guaranteed quality of service is detected via the customer interface 101 in FIG. 2. This request comprises, among other things, the identifier of the customer 108a and the identifier of the requested service, even a password.

In the next step E301, a check is carried out as to whether the customer having sent the request is authorized to access the service with guaranteed quality of service. For this, the ingress edge router 100a, to which the customer 180a having sent the request is linked, transfers the access request to the network controller 160. The network controller 160 interrogates the service provider 170 which, in return, authorizes or denies the customer 180a access to the service with guaranteed quality of service.

In the next step E302, the ingress edge router 100 checks whether the customer is authorized or denied access. If not, in the step E303, a denial message is transmitted via the customer interface 101 to the customer 180 having sent the request. If the check is positive, the algorithm goes on to the next step E304.

In the step E304, the various traffic engineering parameters corresponding to the service requested by the customer 180a and the rules applicable for making available resources of the MPLS network 150 are obtained. The parameters and rules are obtained from the processing rules base 105 and/or from the network controller 160. It should be remembered here that the engineering parameters are, for example and in a non-limiting way, the bit rate allocated for a service, the processing delay and the traffic engineering service class, and the fact that the service is unidirectional or bidirectional. The applicable rules are, for example, and in a non-limiting way, the maximum bit rate allowed for all the services requested by the customer 180a and/or the maximum number of sessions authorized for the customer 180a. When the rules and parameters have been obtained, the algorithm goes on to the next step E305 which consists in transferring the latter to the tunnel agent module 107. Furthermore, with the class of the service requested by the customer 180a taken in the sense of the DiffServ recommendation, the IP addresses of the customer 180 and his correspondent are also transferred to the tunnel agent 107.

The next step E306 consists in searching to see if a tunnel of the MPLS network 150 is able to support the requested service. For this, the tunnel agent module 107 consults a tunnel table comprising, among other things, the source and the destination of each tunnel and the available bandwidth of each tunnel, the processing delay, the traffic engineering service class, and the fact that the service is unidirectional or bidirectional. It should be noted here that the tunnels of the MPLS network 150 can be created centrally or by each ingress edge router 100 of the MPLS network 150. These tunnels can be created based on average traffic forecasts and traffic statistics. These tunnels or at least some of these tunnels can also be created dynamically according to the one-off requirements of the customers 180 of the MPLS network 150.

In the next step E307, a check is carried out to see if there is a tunnel suited to the requirements of the requested service. If there is, the processor goes on to the step E311 which will be described later. If not, the algorithm goes on to the step E308.

The following step E308 consists in searching for a new tunnel in the MPLS network 150. For this, the greatest available bandwidth in the MPLS network 150 between the ingress edge router 100 and the egress edge router 120 to which the correspondent of the customer 180 having sent the request is linked is determined. For example, it can be determined that the path between the ingress edge router 100 and the egress edge router 120 marked by the arrows 105a, 106 and 107 of FIG. 1 is the path which has the greatest bandwidth. A check is then carried out to see if this bandwidth is greater than or equal to the bandwidth required for the requested service.

When this operation is completed, the algorithm goes on to the next step E309. The step E309 consists in determining if a new tunnel can be created in the MPLS network 150. A check is carried out to ensure that the greatest available bandwidth in the MPLS network 150 between the ingress edge router 100 and the egress edge router 120 is greater than the bandwidth required for the requested service. If it is, a new tunnel is created by the ingress edge router 100 and the algorithm goes on to the step E311. If not, the algorithm goes on to the step E310 which consists in generating a message to the customer 180 having sent the request indicating that the MPLS network 150 is saturated and that it is not possible to satisfy the service setup request. When the message is transferred, the present algorithm terminates and awaits a new request from a customer 100 in the step E300.

If the test of the step E307 or of the step E309 is positive, the algorithm goes on to the step E311. In this step, the customer session database 106 is updated by inserting the new data flow into it.

In the next step E312, a message accepting the request from the customer to set up a service with guaranteed quality of service in the telecommunication network is transferred to the customer 180.

The next step E313 is a loop awaiting the end of the newly established session. When the session is stopped, the algorithm goes on to the next step E314 and updates the customer session database 106 by deleting the data flow from it. When the customer session database 106 is updated, the present algorithm terminates and awaits a new request from a customer 100 in the step E300.

Naturally, the present invention is by no means limited to the embodiments described here, but, on the contrary, encompasses any variant within the scope of those skilled in the art.

1. A method of controlling admission to a service with guaranteed quality of service in a label-switched telecommunication network, the label-switched telecommunication network comprising at least one ingress edge router and one egress edge router, the data flows being carried in the label-switched telecommunication network by tunnels, which method comprises the steps performed by the ingress edge router of:
receiving a request from a customer to set up a service with guaranteed quality of service in the telecommunication network,
obtaining traffic engineering parameters corresponding to the service requested by the customer,
determining whether a tunnel to carry the data flow or flows linked to the service with guaranteed quality of service can be created between the ingress edge router and the egress edge router in the label-switched telecommunication network,
transferring to the customer a message denying the request from the customer to set up a service with guaranteed quality of service in the telecommunication network if a tunnel to carry the data flow or flows linked to the service with guaranteed quality of service cannot be created between the ingress edge router and the egress edge router in the label-switched telecommunication network.

2. The method as claimed in claim 1, wherein, if a tunnel to carry the data flow or flows linked to the service with guaranteed quality of service can be created between the ingress edge router and the egress edge router in the label-switched telecommunication network, the method comprises a step of transferring a message to the customer accepting the request from the customer to set up a service with guaranteed quality of service in the telecommunication network.

3. The method as claimed in claim 1, wherein, prior to the step for determining whether a tunnel to carry the data flow or flows linked to the service with guaranteed quality of service can be created between the ingress edge router and the egress edge router in the label-switched telecommunication network, the method comprises a step for determining whether a tunnel of the label-switched telecommunication network is able to carry the data flow or flows linked to the service with guaranteed quality of service between the ingress edge router and the egress edge router.

4. The method as claimed in claim 1, wherein, in the step for obtaining traffic engineering parameters corresponding to the service requested by the customer, the method also obtains rules applicable to the customer to make available resources of the label-switched telecommunication network.

5. The method as claimed in claim 4, wherein, prior to the step for obtaining traffic engineering parameters corresponding to the service requested by the customer and rules applicable to the customer for making available resources of the label-switched telecommunication network, the method comprises the step for checking, via a network controller, whether the customer having sent the request is authorized to access the service with guaranteed quality of service.

6. The method as claimed in claim 5, wherein, the traffic engineering parameters corresponding to the service requested by the customer comprise at least one of the elements of the group containing the bit rate allocated for a service, the processing delay, the traffic engineering service class and the fact that the service is unidirectional or bidirectional.

7. The method as claimed in claim 6, wherein, the rules applicable to the customer comprise at least one of the elements of the group containing the maximum bit rate authorized for all the services requested by the customer and the maximum number of sessions authorized for the customer.

8. The method as claimed in claim 2, which method comprises a step for updating a database referencing all accesses by the customers linked to the ingress edge router to the services with guaranteed quality of service in the telecommunication network.

9. A device for controlling admission to a service with guaranteed quality of service in a label-switched telecommunication network, the label-switched telecommunication network comprising at least one ingress edge router and one egress edge router, the data flows being carried in the label-switched telecommunication network by tunnels, wherein the admission control device is included in the ingress edge router and comprises:
means of receiving a request from a customer to set up a service with guaranteed quality of service in the telecommunication network,
means of obtaining traffic engineering parameters corresponding to the service requested by the customer and rules applicable for making available resources of the label-switched telecommunication network,
means of determining whether a tunnel to carry the data flow or flows linked to the service with guaranteed quality of service can be created between the ingress edge router and the egress edge router in the label-switched telecommunication network,
means of denying the request from the customer to set up a service with guaranteed quality of service in the telecommunication network if a tunnel to carry the data flow or flows linked to the service with guaranteed quality of service cannot be created between the ingress edge router and the egress edge router in the label-switched telecommunication network.

10. A computer program stored on an information medium, said program comprising instructions for implementing the method as claimed in claim 1, when it is loaded and run by a computer system.
